(19) United States
(12) Patent Application Publication
(10) Pub. No.: US 2019/0086243 A1
(43) Pub. Date: Mar. 21, 2019

(54) FIBER OPTIC POLARIZATION MODULATED EVENT MONITOR

(71) Applicant: Petrospec Engineering INC., Sherwood Park (CA)

(72) Inventors: Trevor Wayne MACDOUGALL, Dartmouth, MA (US); Yi YANG, Vernon, CT (US)

(21) Appl. No.: 16/104,873

(22) Filed: Aug. 17, 2018

Related U.S. Application Data
(60) Provisional application No. 62/546,939, filed on Aug. 17, 2017.

(51) Int. Cl. G01D 5/34; G01D 5/353

(52) U.S. Cl. CPC G01D 5/344; G01D 5/35341

(57) ABSTRACT

A system for monitoring events using fiber optics has a length of fiber optic cable having a first end, a second end and a detection length disposed between the first end and the second end. An optical signal source introduces an optical signal into the first end of the fiber optic cable. A detector detects a strength of the optical signal at the second end of the fiber optic cable.

### FIELD

The present disclosure relates generally to optical fiber sensors, and more particularly to a fiber optic polarization modulated event monitor for detecting dynamic events acting on optical fibers.

### BACKGROUND

Dynamic sensing of optical fibers may be used to track and measure events with some frequency or time-resolved component—typically a few Hz to above 30 Hz, such as vibration, acoustic, rotation rate, pressure, temperature, magnetic field, or other physical parameter that alters light propagation in an optical fiber. These changes are tracked over time and processed to provide a measurement of some parameter acting on a length of fiber.

Typically this measurement is performed using phase sensitive optical interferometers which, although highly sensitive, are difficult to construct and involve complex and expensive signal detection and processing equipment and software. This limits the cost effectiveness of the interferometric approach to address a number of applications beyond ones that can justify a high cost per sensing point. Other sensing techniques are disclosed in U.S. Patent Application Publication No. 2009/0290147, which is incorporated by reference herein in its entirety. As will be readily appreciated, existing optical fiber sensors for detecting and monitoring dynamic events, such as those disclosed in the '147 publication, typically operate in reflection mode.

In connection with the above, to date, solutions for performing distributed acoustic, vibration or event monitoring have mainly included optical Coherent Rayleigh backscatter systems employed with fiber optics. These systems typically employ a highly complex optical time-domain reflectometry (OTDR) phase detection instrument to demodulate the phase sensitive coherent Rayleigh backscatter signal. The nature of the mechanical disturbances that create these phase changes along the length of the optical fiber can then be determined.

Recently, however, the desire has been expressed to measure dynamic events acting on a fiber over long distances. For example, there has been a desire to measure mechanical disturbances over long distances in excess of where typical sensors operating in a refection mode are capable of measuring, and hence, existing systems, sensors and methods, are generally not well-suited for such task.

What is needed therefore, is an optical sensor or event monitor capable of detecting and measuring mechanical disturbances over long distances.

### SUMMARY

The present system and method relates to the use of fiber sensing techniques applied to detect or monitor for dynamic events acting on an optical fiber, and that may be used to detect dynamic events over long distances. The system and method may be used to provide a fiber optic polarization modulated event monitor for detecting dynamic events over long distances.

According to an aspect, there is provided a system for monitoring events using fiber optics, comprising a length of fiber optic cable having a first end, a second end and a detection length disposed between the first end and the second end. An optical signal source introduces an optical signal into the first end of the fiber optic cable. A detector detects a strength of the optical signal at the second end of the fiber optic cable.

According to other aspects, the system may comprise one or more of the following features, alone or in combination: there may further comprise a first polarizer, or a first polarizer and a second polarizer, wherein the first polarizer is coupled within the fiber optic cable between the optical signal source and the detection length, and the second polarizer coupled within the fiber optic cable between the detector and the detection length; the detection length may be greater than 100 meters, 1,000 meters, or greater than 10,000 meters; the system may further comprise a semi-reflective element coupled within the fiber optic cable between the optical signal source and the detector, the semi-reflective element reflecting a portion of the optical signal toward the first end of the fiber optic cable, and a reflection detector at or toward the first end of the fiber optic cable relative to the detection length, the reflection detector detecting a strength of the reflected portion of the optical signal in the fiber optic cable; the fiber optic cable may be bidirectional, the optical signal source may introduce a first optical signal into the first end and a second optical signal into the second end of the fiber optic cable, the detector may detects a strength of the first optical signal at the second end of the fiber optic cable, and a further detector that detects a strength of the second optical signal at the first end of the fiber optic cable.

According to an aspect, there is provided a method of monitoring events using fiber optics, comprising the steps of: providing a fiber optic cable having a first end, a second end and a detection length disposed between the first end and the second end; introducing an optical signal source that introduces an optical signal into the first end of the optical path; detecting a strength of the optical signal at the second end of the optical path; and monitoring the detected strength of the optical signal for a dynamic event.

The method may further comprise one or more of the following steps, alone or in combination as applicable: the dynamic event may comprise at least one of vibration, acoustic, rotation rate, pressure, temperature, and magnetic field applied to the detection length of the fiber optic cable; the optical signal may be polarized before the detection length, or before and after the detection length of the fiber optic cable; the detection length may be greater than 100 meters, 1,000 meters, or 10,000 meters; there may be a semi-reflective element coupled within the fiber optic cable between the optical signal source and the detector, the semi-reflective element reflecting a portion of the optical signal toward the first end of the fiber optic cable, and the method further comprising the step of detecting a strength of the reflected portion of the optical signal at or toward the first end of the fiber optic cable relative to the detection length; the optical signal may be polarized before the detection length, or before and after the detection length of the fiber optic cable; the method may further comprise the steps of coupling a first optical signal into the first end of the fiber optic cable, coupling a second optical signal into the second end of the fiber optic cable, detecting a strength of the first optical signal at the second end of the fiber optic cable, and detecting a strength of the second optical signal at the first end of the fiber optic cable.

In other aspects, the features described above may be combined together in any reasonable combination as will be recognized by those skilled in the art.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a schematic illustration of an event monitor in the form of an optical fiber sensor system, according to an embodiment of the present invention.

FIG. 2 is a schematic illustration of an event monitor in the form of an optical fiber sensor system, according to another embodiment of the present invention.

FIG. 3 is a schematic illustration of an exemplary implementation of the sensor system of FIG. 1, with a polarizer.

FIG. 4 is a schematic illustration of an exemplary implementation of the sensor system of FIG. 1, without a polarizer.

FIG. 5 is a schematic illustration of another exemplary implementation of the sensor system of FIG. 1.

FIG. 6 is a schematic illustration of an exemplary implementation of the sensor system of FIG. 2.

FIG. 7 are charts of the transmission signal amplitude and transmission spectrum.

FIG. 8 is a further schematic illustration of a further exemplary implementation of the sensor system of FIG. 1.

### DETAILED DESCRIPTION OF THE PREFERRED EMBODIMENT

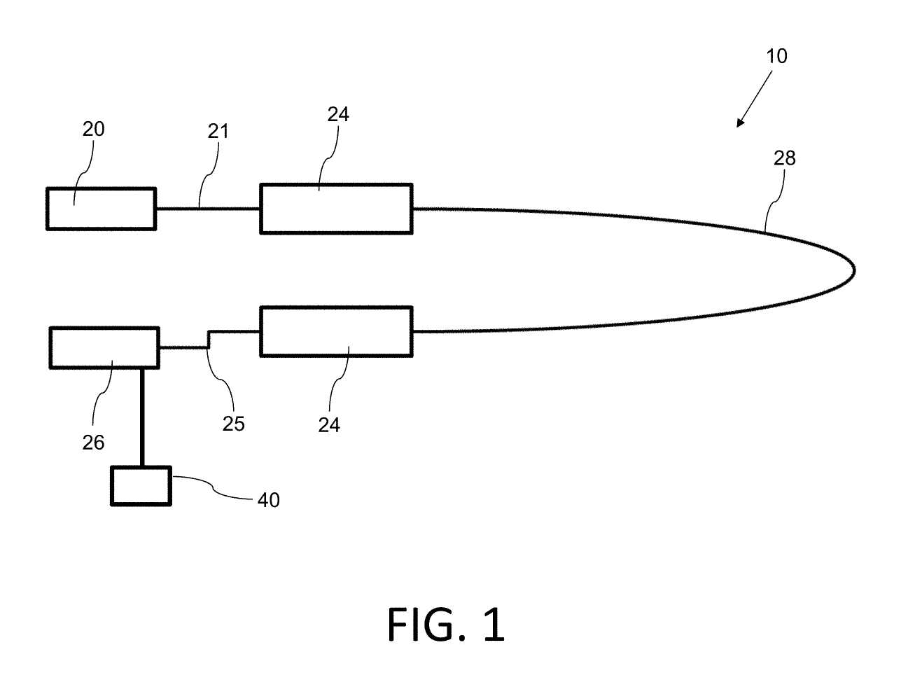

Referring to FIG. 1, an optical fiber sensor system 10 is shown. Sensor system 10 is configured to detect and measure dynamic events, such as mechanical disturbances, over long distances. As used herein, “long distance” means in excess over hundreds of meters and, more preferably, in excess of thousands of meters. These disturbances can be composed of either acoustic pressures or vibrations which causes masses to move. For example, in an embodiment, it is contemplated that an optical fiber can be coupled to an object structure or over its length in order that the sensor system 10 in optical communication with the fiber can detect and measure dynamic events acting on, or within, the object or structure. The optical fiber may also be placed along the boundary of an area to be monitored for dynamic events, such as events that alter light propagation through the optical fiber, such as may occur as a result of vibration, acoustic, rotation rate, pressure, temperature, magnetic field, or other physical parameter.

Importantly, by understanding the mechanical disturbance over the length of an object, the health and mechanical state of the object can be better understood. In the case of pipelines (both surface and in-well), fluid flow information may also be obtained. As alluded to above, using a long length of optical fiber mechanically coupled to/along an object such as a pipeline, mechanical events or disturbances can be measured in magnitude, and the location of such mechanical events or disturbances can be determined. As a result, a complete picture of the dynamic mechanical state of the object or structure can be constructed.

In connection with the above, FIG. 1 illustrates a configuration of an optical fiber sensor system 10 that operates in a transmission mode. As shown therein, the optical fiber sensor system 10 is unidirectional and operates in transmission mode using a single mode optical fiber. EMR (electromagnetic radiation) source 20 is connected to, and provides an optical signal into, an optical network first end 21. Source 20 generates an optical signal that passes through a first polarizer 24, preferably a linear polarizer, and into a length of optical fiber 28. Optical fiber 28 transmits the optical signal along an optical path, which will typically involve long distances. The optical signal passes through another polarizer 24 at the second end 25 of optical fiber 28 where the optical path ends at an optical detector 26. As shown, optical detector 26 is connected to communicate with a processor 40 that may analyze the output optical signal. For example, processor 40 may be used to monitor the detected signal strength, and trigger an alarm condition if certain parameters are reached. The conditions that trigger an alarm condition may depend on the preferences of the user, and may be analyzed in either the time domain or the frequency domain. For example, the detector may monitor for a particular frequency or range of frequencies, a signal strength that is greater than a predetermined level, etc. If the signal strength is compared to a predetermined level, the level may be a fixed value entered by a user, or a value that is calculated by processor 40 based on an expected signal strength calculated for a period of time. the signal strength may be monitored either in the time domain, or the frequency domain

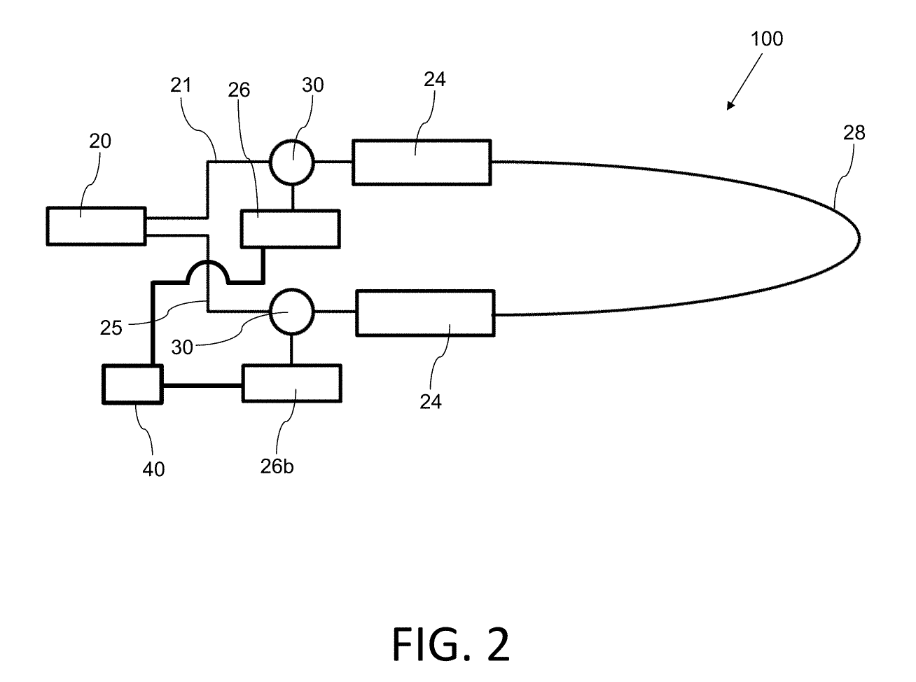

FIG. 2 depicts a second embodiment of event monitor 10 where event monitor 10 is in a bidirectional configuration, henceforth referred to as bidirectional event monitor 100. EMR source 20 outputs first and second optical signals into each of the first end 21 and second end 25 of the optical fiber 28. The signal that is input into first end 21 passes through a polarizer 24, and along the detection length of optical fiber 28, and a second polarizer 25. the detection length of optical fiber 28 may be considered the distance between components that will allow a detection event to be detected. It may also refer to the distance that is exposed to such an event, depending on how and where optical fiber 28 is installed. After passing through the second polarizer 25, it passes into a second optical detector 26b, as directed by a unidirectional coupler 24. The second optical signal that is input into optical fiber 28 follows a similar path to the first optical signal only in a reverse direction, and ends at optical detector 26a as directed by another unidirectional coupler 24. Signals related to the magnitude of the detected optical signal as measured by each detector 26a and 26b may be communicated to processor 40 to perform analysis on the output optical signals.

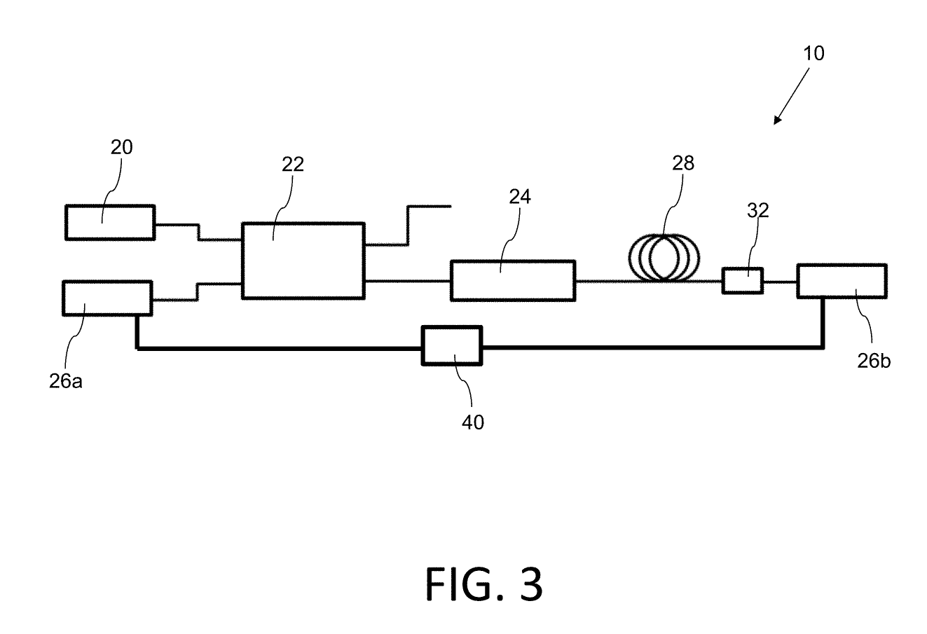

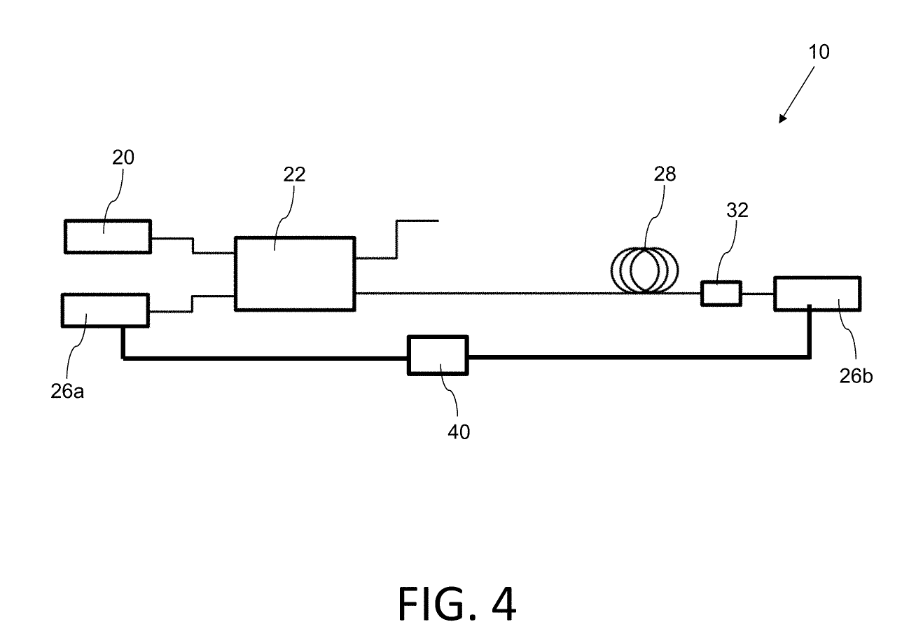

FIGS. 3 and 4 illustrate an exemplary implementation of the system 10 of FIG. 1, where system 10 in FIG. 3 uses a polarizer 24, and FIG. 4 does not. In particular, FIG. 3 is an implementation of event monitor 10 in the unidirectional configuration. EMR source 20 outputs an optical signal into an input of 50/50 coupler 22, which couples the optical signal into optical fiber 28, where it passes first through a polarizer 24 and then along the detection length of optical fiber 28. It will be understood that other types of couplers and optical components generally, may be substituted for those depicted. As the signal passes along optical fiber 28, the signal encounters a fiber Bragg Gratin (FBG) 32. FBG 32 allows a portion of the optical signal to pass through to optical detector 26b and reflects a portion of the optical signal back through optical fiber 28, polarizer 24 and ultimately to optical detector 26a. By comparing the detected signal from optical detector 26a, and 26b, more information or more accuracy may be obtained. As an example, a dynamic event that interacts with optical fiber 28 upstream of FBG 32 will affects the signal as detected by optical detectors 26a and 26b, while an event that interacts with optical fiber 28 downstream of FBG 32 will only affect the signal as detected by optical detector 26b. As an aside, this principle may be used to provide additional resolution in locating an event along optical fiber 28, and may be enhanced by including additional FBGs 32 that are tuned to different frequencies. However, this requires optical detector 26a to be able to distinguish between different wavelengths of light, which increases costs.

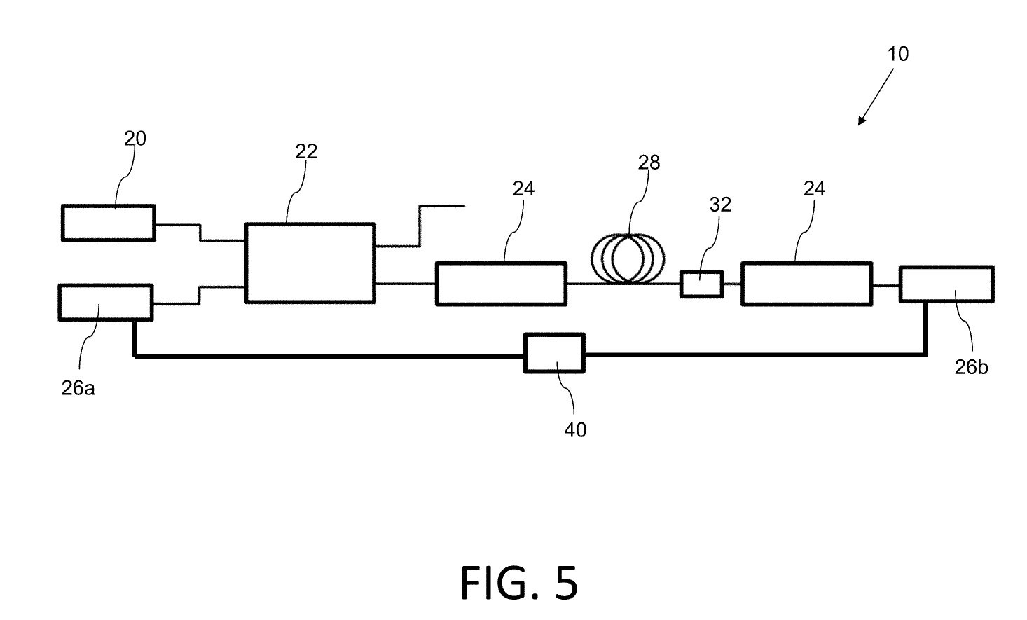

The embodiment depicted in FIG. 5 is a unidirectional configuration that has polarizers 24 at the beginning and end of the detection length of optical fiber 28. Polarizers 24 are placed upstream of detector 26b, and downstream of coupler 22. If the components are arranged in other ways, generally speaking polarizer 24 is intended to be downstream of both signal generator 20 as well as detector 26a.

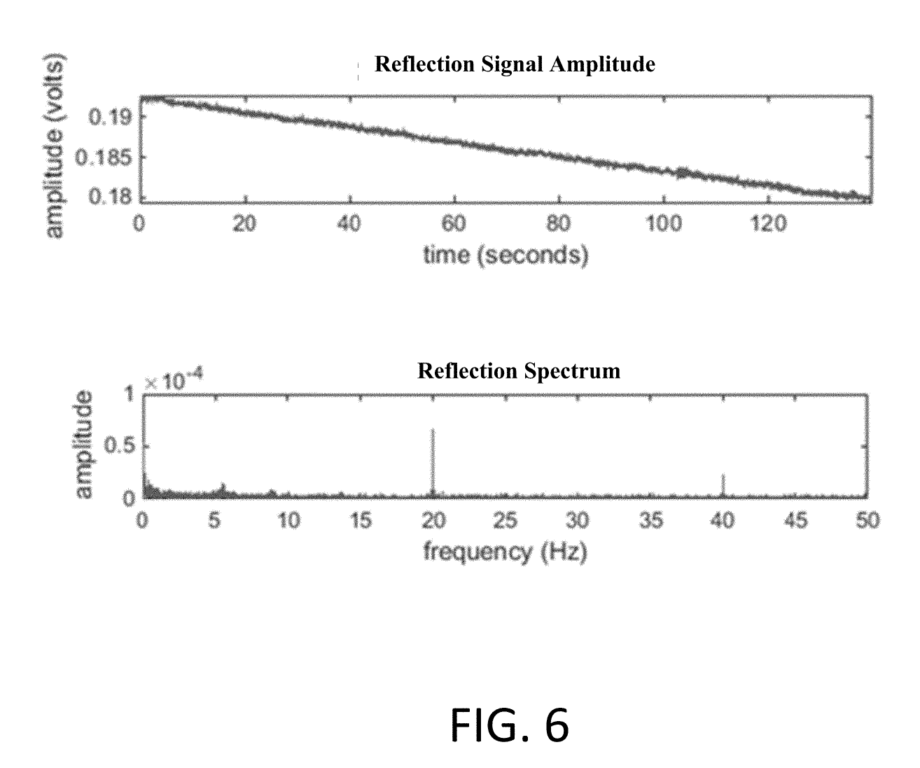

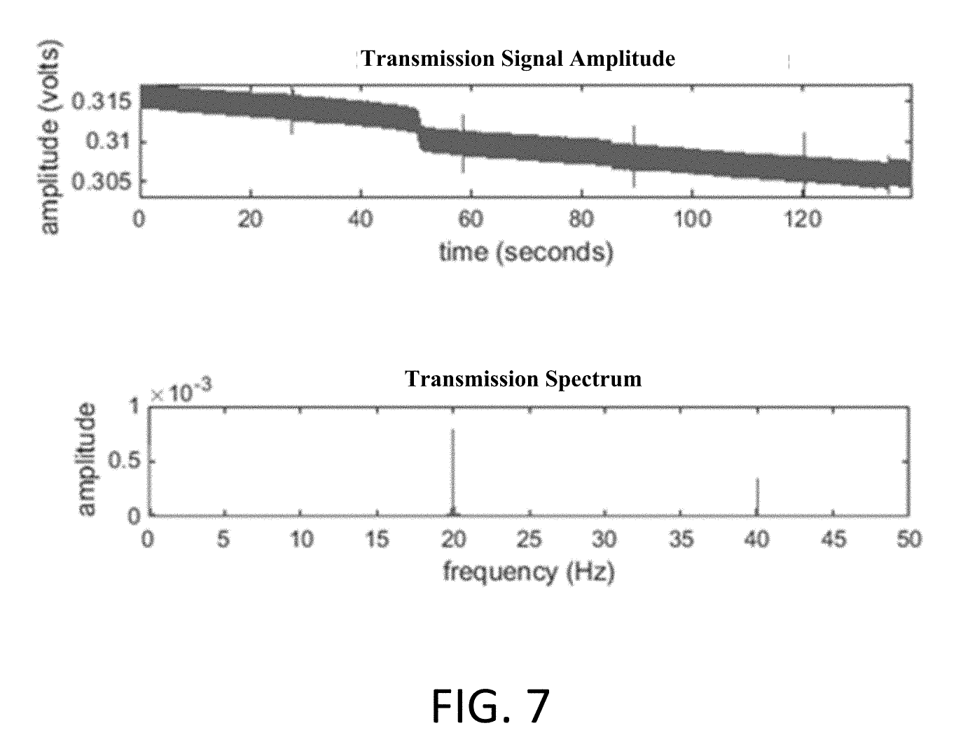

FIGS. 6 and 7 show an example of signals that were collected by optical detectors 26 in an arrangement similar to what is depicted in FIG. 5. In this example, a 20 Hz acoustic signal is incident upon optical fiber 28. FIG. 6, the top graph shows the reflected optical signal as collected by optical detector 26a in FIG. 5, while the bottom graph of FIG. 6 is the frequency spectrum of the signal of the top graph. The peak at 20 Hz (and the harmonic at 40 Hz) corresponds to the alteration of the optical signal due to the acoustic waves, showing how the configuration may be used to detect disturbances along the length of optical fiber 28. FIG. 7 shows similar graphs for the transmitted signal collected at optical detector 26b. The transmitted signal shows a peak at 20 Hz as well, indicating that both of the optical detectors can be used to detect disturbances.

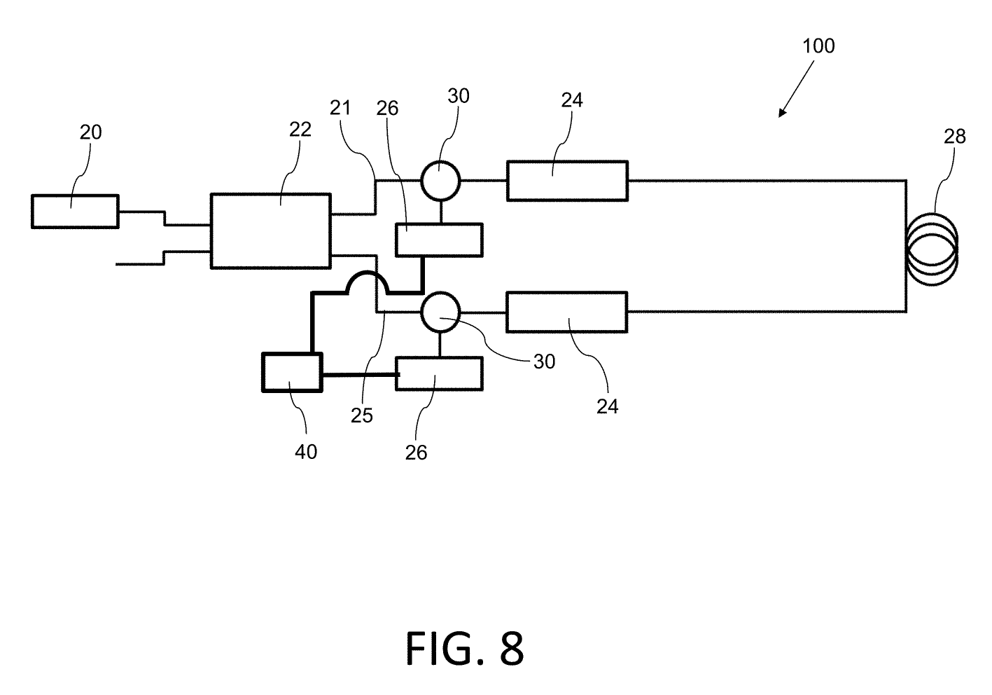

Another embodiment of bidirectional event monitor 100 is shown in FIG. 8. In this embodiment, source 20 communicates the optical signal into a 50/50 coupler 22, which couples the signal into first and second ends 21 and 25 of optical fiber 28. Other types of couplers may also be used, as is known in the art.

Importantly, the advantages of the transmission mode configurations illustrated in FIGS. 1 and 2 include more optical power and higher signal to noise ratio. This will increase fidelity and sensor reach which is important in certain applications for the technology in monitoring long assets such as borders and pipelines. In addition, the sensor systems discloses herein are less costly to implement, less complicated, more reliable and less sensitive as compared to existing systems and methods.

It will be understood that, while polarizers 24 are preferred as they increase the sensitivity of the event monitor, but they increase the cost of the monitors, and in some cases, monitors with fewer or no polarizers may prove sufficient to detect disturbances in some circumstances.

Optical fiber 28 may be single mode, or multimode fiber. Single mode fiber has the advantage of a lower signal attenuation along its length, and may be beneficial to use in applications where very long lengths of fiber are used. Multimode fibers allow multiple frequencies to be transmitted through optical fiber 28, and is typically less expensive, however signal attenuation is higher. As such, single mode fibers can be used over longer distances than multimode fibers. When multimode fibers are paired with multiple FBGs spaced along the length of fiber 28, spatial information about where disturbances occurs along fiber 28 can be determined. In this configuration, only the modes that have their corresponding FBG after the disturbance will be reflected with the disturbance encoded within the signal. Modes that are reflected before the disturbance will not be affected, and the location of the disturbance can be located. The same principle can be applied to a single mode fiber used in conjunction with a single FBG, but the information would be limited to determining if the disturbance is either before or after the FBG.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings, but should be given the broadest interpretation consistent with the description as a whole.

1. A system for monitoring events using fiber optics, comprising:
a length of fiber optic cable having a first end, a second end and a detection length disposed between the first end and the second end;
an optical signal source that introduce an optical signal into the first end of the fiber optic cable; and
a detector that detects a strength of the optical signal at the second end of the fiber optic cable.

2. The system of claim 1, further comprising a first polarizer, or a first polarizer and a second polarizer, wherein the first polarizer is coupled within the fiber optic cable between the optical signal source and the detection length, and the second polarizer coupled within the fiber optic cable between the detector and the detection length.

3. The system of claim 2, wherein the detection length is greater than 100 meters.

4. The system of claim 2, wherein the detection length is greater than 1,000 meters.

5. The system of claim 2, wherein the detection length is greater than 10,000 meters.

6. The system of claim 1, further comprising:
a semi-reflective element coupled within the fiber optic cable between the optical signal source and the detector, the semi-reflective element reflecting a portion of the optical signal toward the first end of the fiber optic cable; and
a reflection detector at or toward the first end of the fiber optic cable relative to the detection length, the reflection detector detecting a strength of the reflected portion of the optical signal in the fiber optic cable.

7. The system of claim 6, further comprising:
a first polarizer coupled within the fiber optic cable between the detection length and the closer of the reflection detector and the optical signal source to the detection length; and
a second polarizer coupled within the fiber optic cable between the detector and the detection length of the fiber optic cable.

8. The system of claim 1, wherein:
the fiber optic cable is bidirectional;
the optical signal source introduces a first optical signal into the first end and a second optical signal into the second end of the fiber optic cable;
the detector detects a strength of the first optical signal at the second end of the fiber optic cable; and
the system further comprises a further detector that detects a strength of the second optical signal at the first end of the fiber optic cable.

9. The system of claim 8, further comprising:
a first polarizer coupled within the fiber optic cable between the detection length and the closer of the reflection detector and the optical signal source to the detection length; and
a second polarizer coupled within the fiber optic cable between the detector and the detection length of the fiber optic cable.

10. A method of monitoring events using fiber optics, comprising:
providing a fiber optic cable having a first end, a second end and a detection length disposed between the first end and the second end;
introducing an optical signal source that introduces an optical signal into the first end of the optical path;
detecting a strength of the optical signal at the second end of the optical path; and
monitoring the detected strength of the optical signal for a dynamic event.

11. The method of claim 10, wherein the dynamic event comprises at least one of vibration, acoustic, rotation rate, pressure, temperature, and magnetic field applied to the detection length of the fiber optic cable.

12. The method of claim 10, wherein the optical signal is polarized before the detection length, or before and after the detection length of the fiber optic cable.

13. The method of claim 12, wherein the detection length is greater than 100 meters.

14. The method of claim 12, wherein the detection length is greater than 1,000 meters.

15. The method of claim 12, wherein the detection length is greater than 10,000 meters.

16. The method of claim 1, further comprising a semi-reflective element coupled within the fiber optic cable between the optical signal source and the detector, the semi-reflective element reflecting a portion of the optical signal toward the first end of the fiber optic cable, and further comprising the step of:
detecting a strength of the reflected portion of the optical signal at or toward the first end of the fiber optic cable relative to the detection length.

17. The method of claim 16, wherein the optical signal is polarized before the detection length, or before and after the detection length of the fiber optic cable.

18. The method of claim 1, further comprising the steps of:
coupling a first optical signal into the first end of the fiber optic cable;
coupling a second optical signal into the second end of the fiber optic cable;
detecting a strength of the first optical signal at the second end of the fiber optic cable; and
detecting a strength of the second optical signal at the first end of the fiber optic cable.
